(19) United States
(12) Patent Application Publication
(10) Pub. No.: US 2005/0049846 A1
(43) Pub. Date: Mar. 3, 2005

(54) Timing soft error check

(75) Inventors: You-Pang Wei, Los Altos, CA (US); Yuhung Liao, Sunnyvale, CA (US); Mingchi Liu, Santa Clara, CA (US); YuJiao Ping, Santa Clara, CA (US)

Correspondence Address: BURNS DOANE SWECKER & MATHIS L L P, POST OFFICE BOX 1404, ALEXANDRIA, VA, 22313-1404, US

(73) Assignee: Legend Design Technology, Inc., Santa Clara, CA (US)

(21) Appl. No.: 10/729,596

(22) Filed: Dec. 5, 2003

Related U.S. Application Data
(60) Provisional application No. 60/497,972, filed on Aug. 25, 2003.

(51) Int. Cl. G06F 17/50

(52) U.S. Cl. 703/19

(57) ABSTRACT

There is provided a method of performing a timing soft error check on a simulated circuit. The method comprises creating a critical-path circuit or using a full-chip circuit to be analyzed of the circuit. Next, the circuit is simulated based on an initial minimum optimization parameter and an initial maximum optimization parameter. A maximum and minimum primary criterion parameter are calculated for each of the minimum and maximum optimization parameters. If the minimum and maximum optimization parameters do not indicate the same status (i.e., both succeed or both fail), then a new current optimization parameter is determined. The circuit is then simulated using the new current optimization parameter. If the simulation is successful, then a timing soft error check is performed. If the simulation is not successful, then it is determined if the primary criterion parameter is converging. If the primary criterion parameter is not converging, then the current optimization parameter is set to a new value.

### RELATED APPLICATIONS

The present application claims the benefit of U.S. Provisional Application No. 60/497,972 entitled “RELIABILITY-BASED CHARACTERIZATION SYSTEM IN IC/SoS DESIGNS” filed Aug. 25, 2003, the entire contents of which are incorporated herein by reference.

### FIELD OF INVENTION

The present invention generally relates to computer aided methods and tools for designing, simulating, characterizing and verifying integrated circuit (IC) designs, and more particularly to a system and method for verifying and characterizing the noise margin of signals within such designs.

### BACKGROUND OF THE INVENTION

The design of very large-scale integrated (VLSI) circuits using computer aided design (CAD) systems is a very time consuming and computationally intensive process. As the complexity of VLSI circuit design has increased, circuit designers have begun incorporating basic circuit building blocks into circuit designs so that the designers do not need to start from scratch for each design. This design approach is commonly referred to as an intellectual property (IP) based design approach and the basic circuit building blocks are referred to as IP blocks.

In accordance with system on chip (SOC) technology, a variety of circuit building blocks are incorporated onto a single integrated chip. Each of the building blocks performs a specific function of an electronic system. The IP building blocks include, but are not limited to, embedded memory, standard cell, 1/O devices, analog and system interfaces, etc.

A timing model including many characterized timing parameters for each IP block that is to be incorporated into a system chip is required by the IC designers. Important timing parameters include setup time, hold time, access time, minimum pulse high and low time, and other 1/O pin characteristics. Designers are interested in characterizing and optimizing timing characteristics associated with an IP block design.

There are two methods of IP block characterization and verification. The first method is based on ‘full circuit’ simulations. For deep submicron designs, a netlist size of layout-extracted IP blocks could be enormous with a large number of resistors and capacitors. It might be prohibitive to run numerous full circuit simulations with a high-accuracy circuit simulator. The other method is a characterization based on ‘critical-path circuit’ simulations. Instead of using a full circuit, a small detailed critical circuit including multiple critical paths is used of simulation. The ‘critical-path circuits’ are built either manually or by software tools for automation, accuracy and performance.

The simulation results observed during the characterization process are only at the pins of the full circuit or at ports of the ‘critical-path circuit’. Reliability issues such as noise margin, glitch, and racing conditions that occur inside the circuit are normally ignored. Accordingly, the timing parameters generated by the simulation may be too optimistic and incorrect.

Furthermore, the circuit or subcircuit block is viewed as a black-box when the circuit simulation is performed. However, the simulations results observed at the pins cannot detect the above-mentioned reliability issues that can occur inside the circuit. The models based upon simulation and characterization results could be incorrect thereby causing yield and reliability problems.

### SUMMARY OF THE INVENTION

In accordance with the present invention, there is provided a method of performing a timing soft error check on a simulated circuit. The method comprises creating a circuit path to be analyzed of the circuit. Next, the circuit is simulated based on an initial minimum optimization parameter and an initial maximum optimization parameter. A maximum and minimum primary criterion parameter are calculated for each of the minimum and maximum optimization parameters. If the minimum and maximum optimization parameters do not indicate the same status then a new current optimization parameter is determined. The circuit is then simulated using the new current optimization parameter. If the simulation is successful, then a timing soft error check is performed. If the simulation is not successful, then it is determined if the primary criterion parameter is converging. If the primary criterion parameter is not converging, then the current optimization parameter is set to a new value.

In the preferred embodiment of the present invention, the new current optimization parameter is determined by averaging the minimum and maximum values of the optimization parameters. The optimization parameter is set to the current minimum optimization value when the current minimum optimization value and the current optimization value indicate the same status (i.e., both indicate succeed or both indicate fail). The optimization parameter is set to the current maximum optimization value when the current minimum optimization value and the current optimization value do not indicate the same status (i.e., one indicates succeed and the other indicates fail). The process reiterates until the primary criterion parameter converges into a specified range. The optimization parameter is a setup or hold time for the circuit simulation, while the primary criterion parameter is a bisection error of the circuit simulation. The circuit simulation is successful and the timing soft error check is performed as determined by a bisection goal.

The timing soft error check comprises determining new maximum and minimum optimization parameters. The current optimization parameter is based on the maximum and minimum optimization parameters. The circuit is then simulated based on the current optimization parameter. A current primary criterion parameter and a secondary criterion parameter are then determined from the circuit simulation. If the primary criterion parameter and the secondary criterion parameter converge into a specified range, then the current optimization parameter is saved as the setup and hold time for the circuit. However, if the primary criterion parameter and the secondary criterion parameter do not converge, then the current optimization parameter is set to a new value.

### BRIEF DESCRIPTION OF THE DRAWINGS

These, as well as other features of the present invention, will become more apparent upon reference to the drawings wherein:

FIG. 1 is a flowchart illustrating a method of performing a reliability-based characterization with a timing soft error check; and

FIG. 2 is a flowchart illustrating a method of performing the timing soft error check used in FIG. 1.

### DETAILED DESCRIPTION

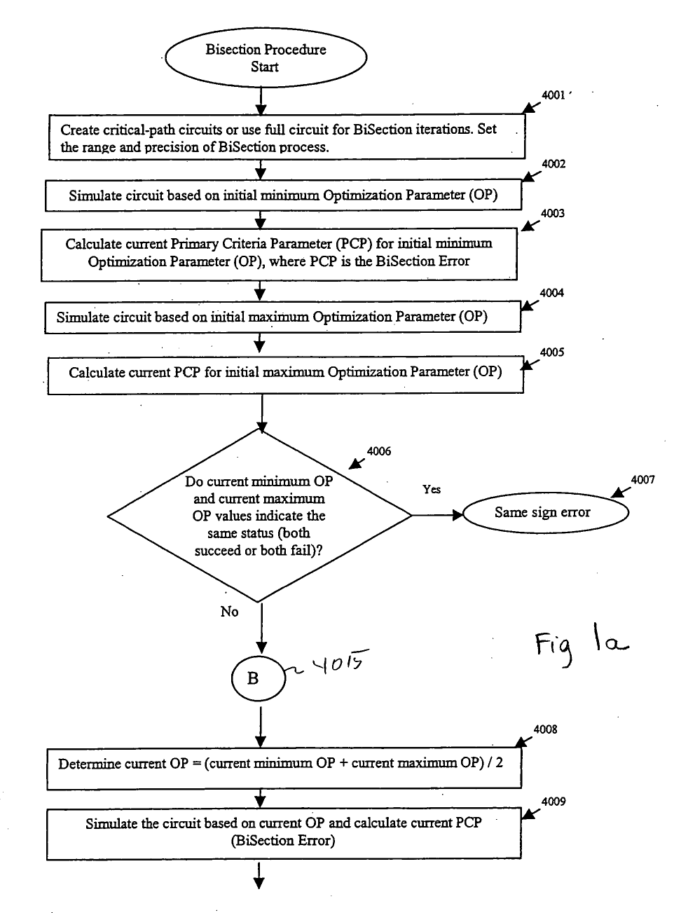

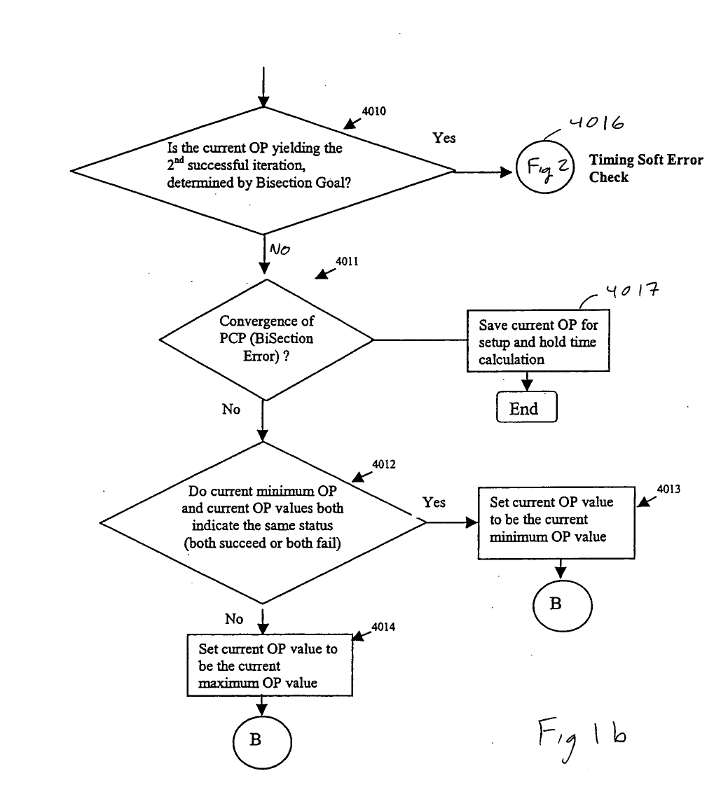

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described. The instructions of a computer program as illustrated in FIG. 1 for performing a soft error timing check can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non exhaustive list) of the computer readable-medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

The present invention generally relates to Applicants' co-pending patent applications: “RELIABILITY BASED CHARACTERIZATION USING BISECTION”, Attorney Docket No. 033994-004; “GLITCH AND METASTABILITY CHECKS USING SIGNAL CHARACTERISTICS”, Attorney Docket No. 033994-005; and “VERIFICATION AND CHARACTERIZATION OF NOISE MARGIN IN INTEGRATED CIRCUIT DESIGNS”, Attorney Docket No. 033994-006, filed concurrently herewith and the entire contents of each application are incorporated herein by reference.

Referring now to the drawings wherein the showings are for purposes of illustrating preferred embodiments of the present invention only, and not for purposes of limiting the same, FIG. 1 is a flowchart illustrating a method of performing a timing soft error check on simulated circuit. The check will assure that the setup and hold time will be an optimized true setup and hold time without a stable access time. Referring to step 4001 of FIG. 1, the critical path circuits or the full circuit for bisection iteration is selected. Furthermore, in step 4001, the range and precision of the bisection process, as well as the clock cycle time need to be selected. Next, in step 4002, the circuit is simulated based upon an initial optimization parameter (OP). The optimization parameter for the timing soft error check is either the setup or hold time for the circuit and may be expressed in nanoseconds. After performing the simulation, the current primary criterion parameter (PCP) is calculated for the initial minimum OP. The PCP is the bisection error for the circuit which is used to indicate the status (either succeed or fail) of a iteration during bisection iteration. In step 4004, the circuit is simulated based on the initial maximum OP as determined by the bisection range and in step 4005, the current PCP is calculated for the initial maximum OP.

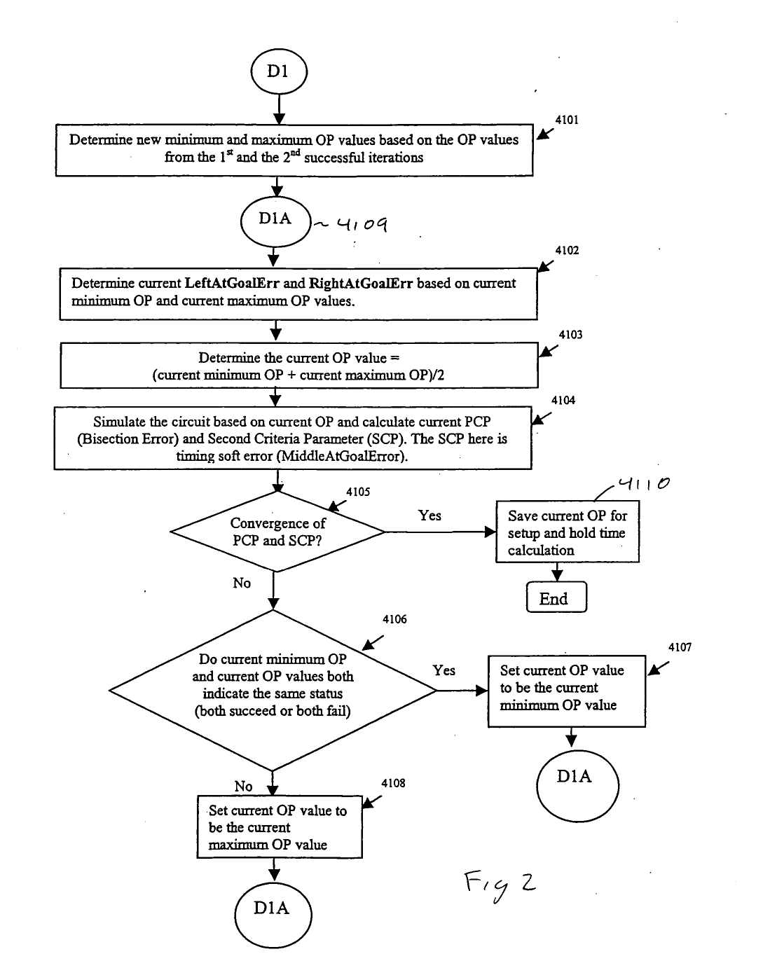

In step 4006, the current minimum OP and the current maximum OP values are compared to determine whether they have the same status. If both the current minimum OP and the current maximum OP both succeed or both fail, then the process ends in step 4007 with a same sign error which means both initial maximum and minimum OP values yield the same bisection status. However, if the current maximum OP and the current minimum OP do not have the same status, then the process proceeds to step 4008 where the current OP is recalculated to be the average of the current minimum OP and the current maximum OP. In step 4009, the circuit is again simulated based on the current OP from step 4008. Furthermore, the current PCP is calculated in step 4009. In step 4010, the current OP is analyzed to determine whether there is a second successful iteration as determined by the bisection goal. If there is a successful second iteration, then the process proceeds to FIG. 2 where a timing soft error check is performed as will be further explained below. However, if there is not a second successful iteration, then the PCP (i.e., bisection error) is analyzed to determine whether there is convergence into a specified bisection error range. If there is convergence, then the current OP is saved for the setup and hold time calculations in step 4017 and the process ends. However, if there is no convergence, then the status of the current minimum OP and the current maximum OP are analyzed to determine whether they are the same (i.e., both succeed or both fail) in step 4012. If they are both the same, then the current OP value is set to be the current minimum OP value in step 4013 and the process returns to step 4015 to perform further bisections. If the status of the current minimum OP and the current maximum OP are not the same in step 4012, then the process proceeds to step 4014 where the current Op value is set to be the current maximum OP value and the process returns to step 4015 for further iterations.

Referring to FIG. 2, the method of performing timing soft error check is shown. As previously mentioned above, if there is a second successful iteration in step 4010 of FIG. 1, then the timing soft error check shown in FIG. 2 is performed. The process begins in step 4101 where new minimum and maximum values for the OP are determined based on the OP values from the first and second successful iterations. Next, in step 4102, the current LeftAtGoalError and RightAtGoalError are determined based on the new minimum and maximum OP values from step 4101. In step 4103, the current OP value is determined as the average of the new minimum and maximum OP values from step 4101. The circuit is simulated in step 4104 based on the current OP such that current PCP and SCP are calculated. The SCP is the timing soft error (MiddleAtGoalError).

In step 4105, the PCP and the SCP are checked to see if they converge into a specified bisection error range. If the PCP and the SCP do converge, then the current OP form step 4103 is saved for setup and hold time calculations. However, if the PCP and the SCP do not converge, then the current minimum OP and the current OP values are compared to see if they have the same status in step 4106. If both the current minimum OP and the current OP values do have the same status (i.e., both succeed or both fail), then the current OP value is set to be the current minimum OP value in step 4107 and the process returns to step 4109 for further iterations. However, the status is not the same, then the process proceeds to step 4108 where the current OP value is set to be the current maximum OP value and the process returns to step 4109 for further iterations.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method for performing a timing soft error check on a simulated circuit, the method comprising the following steps:
using a critical-path or full-chip circuit to be analyzed of the simulated circuit;
simulating the circuit based on an initial minimum optimization parameter and an initial maximum optimization parameter;
calculating a minimum and maximum primary criterion parameter for each of the respective minimum and maximum optimization parameters;
if the minimum and maximum optimization parameters do not indicate the same status, then:
determining a new current optimization parameter;
simulating the circuit based on the new optimization parameter;
if the simulation is successful, then performing a timing soft error check;
if the simulation is not successful then determining if the primary criterion parameter is converging into a specified range; and
setting the current optimization parameter to a new value if the primary criterion parameter is not converging into a specified range.

2. The method of claim 1 wherein the new current optimization parameter is determined by averaging the minimum and the maximum optimization parameters.

3. The method of claim 1 wherein the optimization parameter is set to the current minimum optimization value when the current minimum optimization value and the current optimization value indicate the same status.

4. The method of claim 1 wherein the optimization parameter is set to the current maximum optimization value when the current minimum optimization value and the current optimization value do not indicate the same status.

5. The method of claim 1 wherein the process reiterates until the primary criterion parameter converges into the specified range.

6. The method of claim 1 wherein the optimization parameter is a setup or hold time for the circuit simulation.

7. The method of claim 1 wherein the primary criterion parameter is a bisection error of the circuit simulation.

8. The method of claim 1 wherein the simulation is successful and the timing soft error check is performed as determined by a bisection goal.

9. The method of claim 1 wherein if the primary criterion parameter is converging into the specified range, then the current optimization parameter is the setup and hold time for the circuit simulation.

10. The method of claim 1 wherein the timing soft error check comprises:
determining new maximum and minimum optimization parameters;
determining a current optimization parameter based on the maximum and minimum optimization parameters;
simulating the circuit based on the current optimization parameter;
determining a current primary criterion parameter and a secondary criterion parameter from the circuit simulation;
determining whether the primary criterion parameter and the secondary criterion parameter converge into a specified range;
if the primary criterion parameter and the secondary criterion parameter converge, then saving the current optimization parameter as a setup and hold time for the circuit simulation; and
if the primary criterion parameter and the secondary criterion parameter do not converge, then setting the current optimization parameter to a new value.

11. The method of claim 10 wherein the current optimization value is set to the minimum optimization value if the simulations based on the current minimum and current optimization parameters indicate the same status.

12. The method of claim 10 wherein the current optimization value is set to the maximum optimization value if the simulations based on the current maximum and the current optimization parameters indicate the same status.

13. A method for performing a timing-soft error check and timing characterization simultaneously, the method comprising the steps of:
defining a critical-path or full-chip circuit to be analyzed;
simulating the circuit;
determining an ideal optimization parameter from the circuit simulation; and
performing a timing-soft error check with the ideal optimization parameter.

14. The method of claim 13 comprising the step of iteratively simulating the circuit with new optimization parameters in order to determine the ideal optimization parameter.

15. The method of claim 13 wherein the ideal optimization parameter is determined by performing the following steps:
simulating the circuit with an initial minimum optimization parameter;
simulating the circuit with an initial maximum optimization parameter;
calculating a minimum and maximum primary criterion parameter for each of the respective minimum and maximum optimization parameters;
if the minimum and maximum optimization parameters do not indicate the same status, then:
determining a new current optimization parameter;
simulating the circuit based on the new optimization parameter;
if the simulation is successful, then performing the timing soft error check;
if the simulation is not successful then determining if the primary criterion parameter is converging into a specified range; and
setting the current optimization parameter to a new value if the primary criterion parameter is not converging into the specified range.
